(19) United States
(12) Patent Application Publication
(10) Pub. No.: US 2026/0359487 A1
(43) Pub. Date: Nov. 12, 2026

(54) PRIVACY ENABLED ACCESS TO A DIGITAL ACTION

(71) Applicant: CRUNCHFISH DIGITAL CASH AB, Malmo (SE)

(72) Inventors: Joachim SAMUELSSON, Helsingborg (SE); Paul CRONHOLM, Malmo (SE)

(21) Appl. No.: 19/470,194

(22) PCT Filed: Mar. 28, 2024
(86) PCT No.: PCT/SE2024/050294

§ 371 Date: Sep. 29, 2025

(30) Foreign Application Priority Data
Mar. 29, 2023 (SE) 2350365-9

(51) Int. Cl. G06F 21/62; G06F 21/16; G06Q 20/36; G06Q 20/38; H04L 9/08; H04L 9/30; H04L 9/32

(52) U.S. Cl. CPC G06F 21/629; G06F 21/16; G06F 21/6254; G06Q 20/36; G06Q 20/3823; H04L 9/0825; H04L 9/30; H04L 9/3247; H04L 9/3263; H04L 2209/56

(57) ABSTRACT

A computerized privacy enabling method establishes (110) a unique and anonymous instance of a trusted application (TA), executable in a secure execution environment (SEE) of a host device (HD), by associating the instance with a cryptographic key pair comprising a private cryptographic key (ta priv key) and a public cryptographic key (ta pub key), the public cryptographic key (tajDub key) being certified by a digital certificate authority (CA) and at least the private cryptographic key (ta priv key) being stored securely in the secure execution environment (SEE). The instance of the trusted application (TA) generates and causes (120) transmission of an access request (AccessReq) for a digital action at a communication entity (CE; HS, OS), the access request being signed by the private cryptographic key (ta priv key). The communication entity (CE; HS, OS) verifies (130) the access request (AccessReq) by checking the signature of the access request (AccessReq) using the public cryptographic key (ta pub key), and grants access (140) to the digital action upon successful verification of the access request.

### TECHNICAL FIELD

The present invention generally relates to digital actions. More particularly, the present invention relates to technical improvements to enable privacy in accessing such digital actions from a host device. Even more particularly, the present invention relates to a method, host device, trusted application and computerized resource for enabling of privacy.

### BACKGROUND

In our digitalized society of today, users of host devices frequently request access to digital actions to be performed by communication entities. Host devices may include, for instance, mobile communication devices (e.g. mobile phones or smart phones), tablet computers, personal digital assistants, laptop computers, smart glasses, smart watches, smart cards or smart wearables, without limitation. Communication entities may include for instance, host servers (e.g. remote servers), local area network nodes or peer devices, without limitation. Communication between host devices and communication entities may include, for instance, wide area network communication, local area network communication, short-range wireless data communication or circuit-switched telecommunication, without limitation.

Requesting access to such a digital action conventionally involves a handshake procedure between a software application executing in the requesting host device and the communication entity providing the digital action. The handshake procedure involves bi-directional communication during which the software application identifies itself to the communication entity. This is done in order for the communication entity to trust that performance of the digital action is requested by someone authorized to do so. Directly or indirectly, this also jeopardizes the privacy of a user of the host device, for instance because the user has logged in to the software application and/or the communication entity, or undergone some other registration procedure from which the user can be tracked.

### SUMMARY

In line with the observations above, the present inventors have made valuable technical insights when it comes to the enabling of privacy. These insights will be presented as inventive aspects in the following description and in the drawings. The list of inventive aspects is not to be seen as exhaustive but rather a summary of particularly beneficial inventive aspects.

A first inventive aspect is a computerized privacy enabling method. The method comprises establishing a unique and anonymous instance of a trusted application, executable in a secure execution environment of a host device, by associating the instance with a cryptographic key pair comprising a private cryptographic key and a public cryptographic key, the public cryptographic key being certified by a digital certificate authority and at least the private cryptographic key being stored securely in the secure execution environment.

The method according to the first inventive aspect then comprises, from the instance of the trusted application, generating and causing transmission of an access request for a digital action at a communication entity, the access request being signed by the private cryptographic key.

The method according to the first inventive aspect further comprises the communication entity verifying the access request by checking the signature of the access request using the public cryptographic key.

The method according to the first inventive aspect concludes by the communication entity granting access to the digital action upon successful verification of the access request.

The host device may, for instance, be a mobile communication device (such as a mobile phone or smart phone), tablet computer, personal digital assistant, laptop computer, smart glasses, smart watch, smart card or smart wearable.

The communication entity may, for instance, be a remote server, such as a host server or another server resource. The communication between the host device and the remote server may take place via local and/or wide area network communication, such as TCP/IP. Alternatively, the communication entity may, for instance, be a local node in a local area network, communicating with the host device via Wifi (etc.), or a peer device communication with the host device via short-range wireless data communication, such as Bluetooth, or a node or central resource in a circuit-switched telecommunication network, communicating with the host device via for instance SS7.

The method according to the first inventive aspect enables trust to the communication entity while preserving privacy of the user of the host device. Since the access request emanates from a trusted application in a secure execution environment on the host device and is furthermore signed, the receiving communication entity can trust that a validly signed access request is made by someone authorized to make the request—even though the identity of the requestor is not revealed.

Embodiments of the method according to the first inventive aspect further comprises onboarding of the instance of the trusted application. This is done by the instance of the trusted application requesting a digital certificate which includes the public key, wherein the digital certificate is signed by the digital certificate authority, and by the instance of the trusted application storing the digital certificate in the secure execution environment.

Alternatively, the private cryptographic key, the public cryptographic key as well as a digital certificate, which includes the public key and which is signed by the digital certificate authority, have been pre-provisioned in the secure execution environment prior to the step of establishing the unique and anonymous instance of the trusted application.

Some specific embodiments of the method according to the first inventive aspect further involves onboarding of the instance of the trusted application at a host server, which optionally may be the communication entity, wherein onboarding comprises the following functionality.

By the instance of the trusted application:
generating an anonymous identifier, not attributable to a user of the host device;
generating said private key and said public key of the cryptographic key pair;
storing the private key securely in the secure execution environment; and
making an onboarding request at the host server, the onboarding request being signed by the private key and containing the anonymous identifier or a unique representation thereof, as well as the public key.

By the host server:
verifying the onboarding request by the public key;
causing generation of a digital certificate which includes the public key and the anonymous identifier or its unique representation and which is certified by said digital certificate authority; and
delivering the digital certificate to the host device.

By the instance of the trusted application:
storing the digital certificate in the secure execution environment.

Advantageously, in these specific embodiments, the instance of the trusted application verifies that the digital certificate has been certified by the digital certificate authority before storing the digital certificate in the secure execution environment.

Advantageously, in these specific embodiments, causing generation of the digital certificate by the host server involves the following functionality.

By the host server:
sending a certificate signing request to the digital certificate authority, the certificate signing request comprising the anonymous identifier or the unique representation thereof, the public key as well as a signature made by the instance of the trusted application when signing said onboarding request.

By the digital certificate authority:
verifying the signature using the public key;
creating the digital certificate to include the anonymous identifier or the unique representation thereof, the public key as well as a signature by the digital certificate authority; and
delivering the digital certificate to the host server.

Advantageously, these specific embodiments involve dual signing of the access request at onboarding, wherein:
the secure execution environment of the host device is pre-provisioned with a private cryptographic master key;
the host server is pre-provisioned with a public cryptographic master key corresponding to the private cryptographic master key;
the instance of the trusted application signs the onboarding request by the private cryptographic master key; and
the host server verifies the onboarding request also by the public cryptographic master key.

In some embodiments of the method according to the first inventive aspect, the instance of the trusted application causes transmission of the access request to a host server.

In some embodiments of the method according to the first inventive aspect, the instance of the trusted application causes transmission of the access request to a remote server other than a host server, wherein the digital certificate as requested by the trusted application at onboarding may be included in the access request.

In some embodiments of the method according to the first inventive aspect, the communication entity grants access to the digital action by permitting usage of a digital asset in an anonymous digital account. The anonymous digital account may have been associated previously with the instance of the trusted application and the public cryptographic key upon onboarding of the instance of the trusted application at a host server. Advantageously, after having verified the access request, the communication entity locates the anonymous digital account through its association with the instance of the trusted application and the public cryptographic key.

The method according to the first inventive aspect lends itself well to digital payment applications. Accordingly, in some embodiments of the method, the trusted application supports a payment application executed by the host device, the communication entity is a payment processing server, the anonymous digital account is a digital wallet, the digital asset is a balance of the digital wallet, and the digital action is a digital payment in a payment amount to be debited from the balance of the digital wallet.

Such applications of the method according to the first inventive aspect may further comprise the payment processing server causing settlement of the digital payment to credit the payment amount to a receiving digital account associated with a payee. Advantageously, after settlement, the payment amount as such but no origin of the digital payment in terms of an identity of a payer being a user of the host device is traceable by the payee or the payment processing server. This enables the payer be remain anonymous. In some embodiments, anonymity is offered to the payee as well by the payee being indicated in the access request in the form of an anonymous identifier of an instance of a trusted application in a secure execution environment of a host device operated by the payee, wherein the identity of the payee is therefore not traceable by the payer or the payment processing server.

Advantageously, the secure execution environment of the host device is a software-based virtual execution environment which includes encrypted protected assets being accessible to the instance of the trusted application when executed in the software-based virtual execution environment.

A second inventive aspect is a host device comprising a secure execution environment. The host device is configured for establishing a unique and anonymous instance of a trusted application, executable in the secure execution environment, by associating the instance with a cryptographic key pair comprising a private cryptographic key and a public cryptographic key, the public cryptographic key being certified by a digital certificate authority and at least the private cryptographic key being stored securely in the secure execution environment. The host device is further configured for, from the instance of the trusted application, generating and causing transmission of an access request for a digital action at a communication entity, the access request being signed by the private cryptographic key, thereby enabling the communication entity to verify the access request by checking the signature of the access request using the public cryptographic key, and to grant access to the digital action upon successful verification of the access request.

The host device according to the second inventive aspect may be configured to perform the functionality of the unique and anonymous instance of the trusted application in the method according to the first inventive aspect and/or the embodiments thereof.

A third inventive aspect is a trusted application comprising computer program code being executable in a secure execution environment of a host device. The trusted application is configured for establishing itself as a unique and anonymous trusted application instance by associating the instance with a cryptographic key pair comprising a private cryptographic key and a public cryptographic key, the public cryptographic key being certified by a digital certificate authority and at least the private cryptographic key being stored securely in the secure execution environment. The trusted application is further configured for generating and causing transmission of an access request for a digital action at a communication entity, the access request being signed by the private cryptographic key, thereby enabling the communication entity to verify the access request by checking the signature of the access request using the public cryptographic key, and to grant access to the digital action upon successful verification of the access request.

The trusted application according to the third inventive aspect may be configured to perform the functionality of the unique and anonymous instance of the trusted application in the method according to the first inventive aspect and/or the embodiments thereof.

A fourth inventive aspect is a computerized resource being configured for receiving an access request for a digital action from a unique and anonymous instance of a trusted application, executable in a secure execution environment of a host device and having been established by associating the instance with a cryptographic key pair comprising a private cryptographic key and a public cryptographic key, the public cryptographic key being certified by a digital certificate authority and at least the private cryptographic key being stored securely in the secure execution environment, the access request being signed by the private cryptographic key. The computerized resource according to the fourth inventive aspect is further configured for verifying the access request by checking the signature of the access request using the public cryptographic key, and granting access to the digital action upon successful verification of the access request.

The computerized resource according to the fourth inventive aspect may be configured to perform the functionality of the method according to the first inventive aspect and/or the embodiments thereof. The computerized resource may, for instance, be implemented in or by a server computer or a cloud-based computing environment.

Expressions like “[entity] is configured for . . . [performing activity]” or “[entity] is configured to . . . [perform activity]” will include typical cases where a computerized entity (having one or more controllers, processing units, programmable circuitry, etc.) executes software or firmware installed in the computerized entity, wherein the execution occurs in order to perform the activity in question. It should be emphasized that the term “comprises/comprising” when used in this specification is taken to specify the presence of stated features, integers, steps, or components, but does not preclude the presence or addition of one or more other features, integers, steps, components, or groups thereof. Generally, all terms used herein are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The following detailed description of embodiments of the present invention will be based upon the attached drawings. In the drawings:

FIG. 1A is a schematic block diagram of a host device running a trusted application in a secure execution environment being a software-based virtual execution environment.

FIG. 1B is a schematic block diagram of a host device running a trusted application in a secure execution environment being a hardware-based trusted execution environment.

FIG. 1C is a schematic flowchart diagram of a computerized privacy enabling method according to one inventive aspect.

FIG. 2 is a detailed signal diagram illustrating anonymous onboarding in one embodiment.

FIG. 3 is a detailed signal diagram illustrating privacy enabling access to a digital action without handshakes in one embodiment.

FIG. 4 is a detailed signal diagram illustrating privacy enabling access to a digital action without handshakes in another embodiment.

FIG. 5 is a detailed signal diagram illustrating anonymous payment in one embodiment.

### DETAILED DESCRIPTION

Inventive aspects and embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like reference signs refer to like elements.

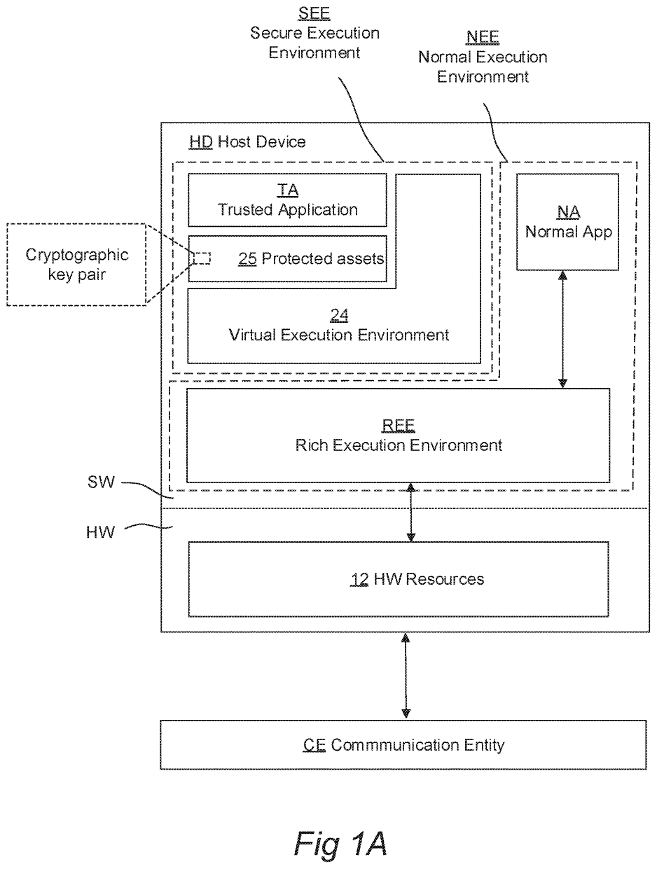

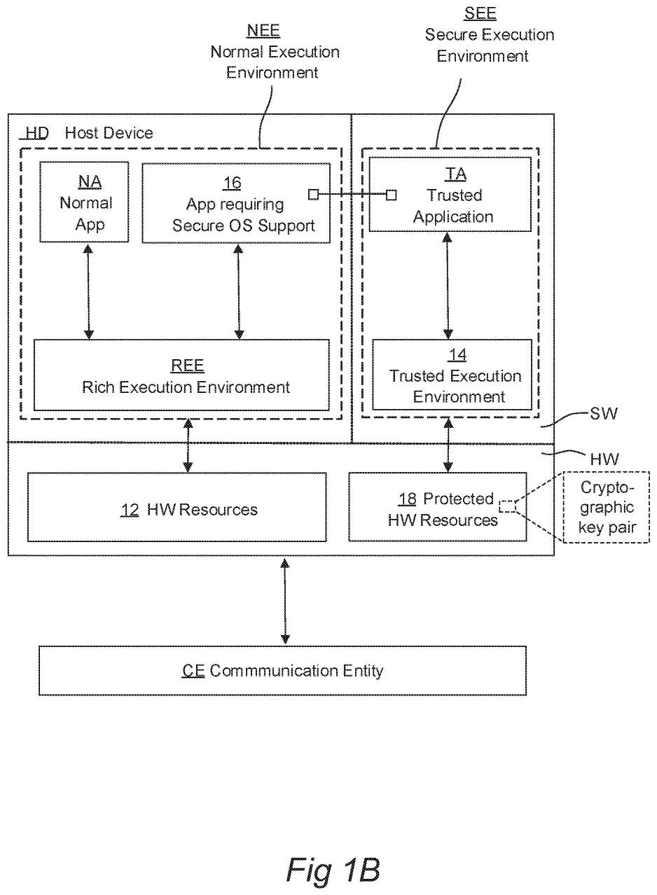

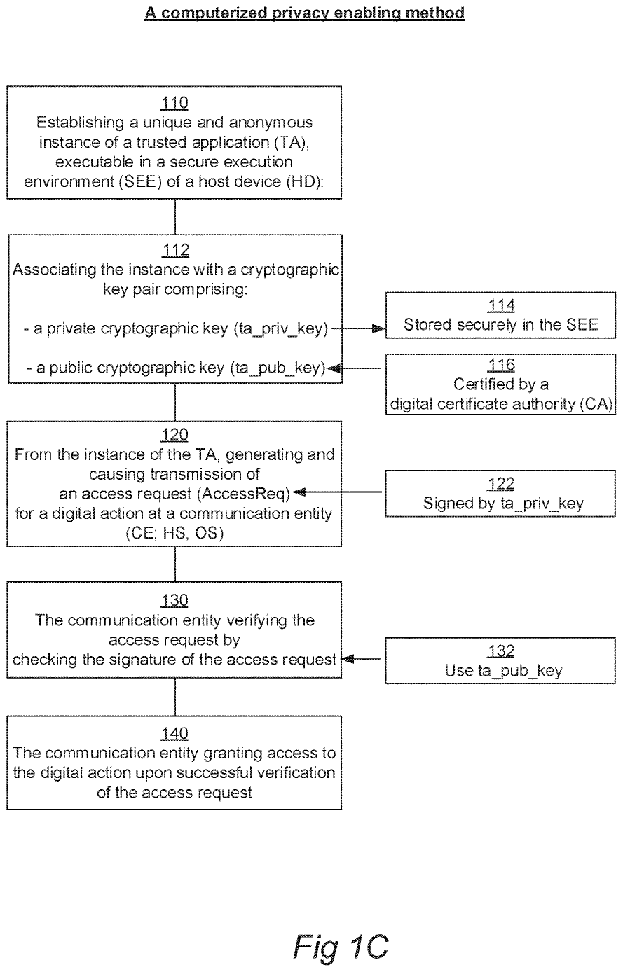

As seen in FIG. 1A, a host device HD is configured for running a trusted application TA. The trusted application TA is executable in a secure execution environment SEE of the host device HD. For instance, the host device HD may be a mobile communication device, such as a mobile phone, smart phone, tablet computer, personal digital assistant, smart glasses, smart watch, smart card or smart wearable (e.g. smart bracelet), or any combination thereof. The host device HD may alternatively be any type of computer device capable of securely executing protected functionality and data, including but not limited to a laptop or desktop computer.

The host device HD shown in FIG. 1A implements a computer architecture scheme that is partitioned into two separate and respectively isolated execution environments, the environments being a normal execution environment NEE and a secure execution environment SEE.

The normal execution environment NEE is a non-secure world in the sense that one or more untrusted “normal” applications NA can be executed in a rich execution environment REE. The rich execution environment REE is adapted to run any type of embedded operating system or a general-use operating system, such as Android, iOS, Linux or Windows. Although not shown, it is implicit that the rich execution environment REE may access the normal applications NA through one or more application programming interfaces (APIs). The normal applications NA may thus be any type of web, native or hybrid applications being provided by an application service provider that is not trusted by the host device HD. The rich execution environment REE is adapted to access hardware resources (including firmware resources) 12 of the host device HD through, for instance, a hypervisor (not shown). Hardware resources 12 may include processing units, DRAMs, drivers, secondary storage, and so forth.

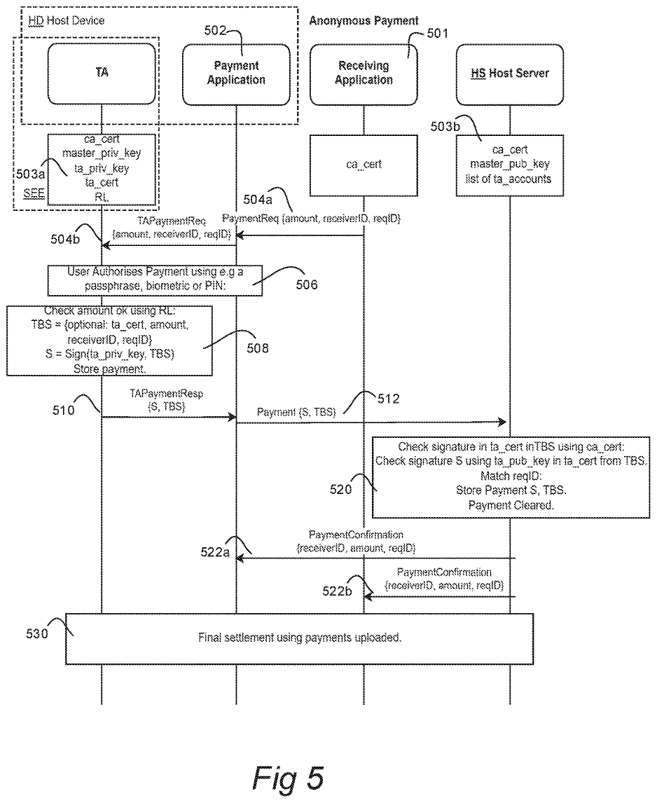

A normal application NA may require secure support from a trusted application TA. An example of this may be a payment application service (normal application NA) being in communication with a secure digital wallet (trusted application TA). One example of a digital payment application for such purposes will be described later with reference to FIG. 5.

Execution of the trusted application TA involves separating it from the normal execution environment NEE and maintaining it in the secure execution environment SEE. The secure execution environment SEE is a secure world in the sense that the trusted application TA can be executed in a secured virtual execution environment 24.

The trusted application TA is thus protected by software. The virtual execution environment 24 is adapted to access and execute encryption-protected assets (data, resources and functionality), as can be seen at 25, for the trusted application TA. In some embodiments, such protected assets 25 may be stored securely, by way of encryption, on any storage media of the host device HD (cf. hardware resources 12), retrieved and decrypted by the trusted application TA at runtime, and encrypted and stored back securely on the storage media of the host device HD. The encryption-protected assets 25 may include at least one cryptographic key pair (or at least the private key(s) of such key pair(s)), the purpose of which will appear from the forthcoming description.

Any suitable virtual execution environment technologies known in the art may be implemented. For instance, the virtual execution environment 24 may be implemented generally as a V-OS Virtual Secure Element by V-Key Inc., and/or generally according to subject-matter disclosed in the European patent EP 2 795 829 B1.

As further seen in FIG. 1A, the host device HD is in communication with a communication entity CE, some details and examples of which will be provided later.

Another embodiment of the host device HD is shown in FIG. 1B. Like the previous embodiment in FIG. 1A, the host device HD in FIG. 1B is configured for running a trusted application TA. The host device HD shown in FIG. 1B implements a hardware-based computer architecture scheme. The architecture scheme partitions a traditional kernel execution environment into two separate and respectively isolated execution environments, the environments being a normal execution environment NEE and a secure execution environment SEE.

The normal execution environment NEE is a non-secure world in the sense that one or more untrusted “normal” applications NA can be executed in a rich execution environment REE. The rich execution environment REE is adapted to run any type of embedded operating system or a general-use operating system, such as Android, iOS, Linux or Windows. Although not shown, it is implicit that the rich execution environment REE may access the normal applications NA through one or more application programming interfaces (APIs). The normal applications NA may thus be any type of web, native or hybrid applications being provided by an application service provider that is not trusted by the host device HD. The rich execution environment REE is adapted to access hardware resources (including firmware resources) 12 of the host device HD through, for instance, a hypervisor (not shown). Hardware resources 12 may include processing units, DRAMs, secondary storage, drivers, and so forth.

A normal application NA may be an application 16 requiring secure operating system support. This application 16 cannot be securely executed in the rich execution environment REE. For instance, the application 16 requiring secure OS support may be an application that comprises information that has to be protected against unwarranted disclosure, i.e. comprising data pertaining to e.g. monetary means, confidentiality information, or some other sensitive data. Alternatively, a computer program may require the execution of two different applications, one being a normal application NA and the other being an application 16 requiring secure OS support. An example of this may be a payment application service (normal application NA) being in communication with a secure digital wallet (application 16 requiring secure OS support). Execution of the application 16 requiring secure OS support involves separating it from the normal execution environment NEE and maintaining it in the secure execution environment SEE as a trusted application TA. The trusted application TA may be a secure digital wallet for a payment application service, such as the aforementioned digital payment application in FIG. 5.

The secure execution environment SEE is a secure world in the sense that the trusted application TA can be executed in a trusted execution environment 14. The trusted execution environment 14 is adapted to access and execute protected functionality and data which are maintained by protected hardware resources 18, e.g. buses, peripherals, memory regions, interrupts, and so forth. Data in the protected hardware resources 18 may include at least one cryptographic key pair (or at least the private key(s) of such key pair(s)), the purpose of which will appear from the forthcoming description. The trusted execution environment 14 may be implemented in any trusted execution environment technology known in the art, including but not limited to Samsung TEEGRIS, Qualcomm TEE, Huawei iTrustee, Trustonic Kinibi, Google Open Source Trusty, Open Portable TEE, Nvidia's Trusted Little Kernel for Tegra, Sierra TEE, ProvenCore TEE, Trusty TEE for Android, or TrustKernel T6. The protected hardware resources 18 may be protected by any hardware support technologies known in the art, including but not limited to Arm's TrustZone, MultiZone Security, AMD Platform Security Processor, Intel Software Guard Extensions, Apple's Secure Enclave Processor, or Google's Titan M.

As further seen in FIG. 1B, the host device HD is in communication with a communication entity CE. The communication entity CE in FIG. 1A or in FIG. 1B, or generally according to the present invention, may, for instance, be a remote server, such as a host server or another server resource. The communication between the host device and the remote server may take place via local and/or wide area network communication. Alternatively, the communication entity may, for instance, be a local node in a local area network, or a peer device communicating with the host device via short-range wireless data communication, or a node or central resource in a circuit-switched telecommunication network, communicating with the host device via for instance SS7.

Communication between the host device HD and the communication entity CE may be via a wide area network over, for instance based on TCP/IP, or alternatively any other suitable types of long-range, local area or short-range communication standards known in the art. For instance, short-range and local area communication may include, for instance, IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, or any other form of proximity-based device-to-device radio communication signal such as LTE Direct. Long-range communication may include, for instance, W-CDMA/HSPA, GSM, UTRAN, LTE or Starlink. Circuit-switched telecommunication may include, for instance, SS7.

Reference is now made to FIG. 1C, presenting a schematic flowchart diagram of a computerized privacy enabling method according to one inventive aspect. As seen in FIG. 1C, the computerized privacy enabling method comprises establishing 110 a unique and anonymous instance of the trusted application TA, executable in the secure execution environment SEE of the host device HD, by associating 112 the instance with a cryptographic key pair comprising a private cryptographic key ta_priv_key and a public cryptographic key ta_pub_key. The public cryptographic key ta_pub_key is/has been certified 116 by a digital certificate authority CA. At least the private cryptographic key ta priv_key is being stored securely 114 in the secure execution environment SEE, cf. protected assets 25 in FIG. 1A and protected hardware resources 18 in FIG. 1B.

The computerized privacy enabling method further comprises, from the instance of the trusted application TA, generating and causing 120 transmission of an access request AccessReq for a digital action at the communication entity CE. The access request is being signed 122 by the private cryptographic key ta_priv_key.

Upon receipt, the communication entity CE verifies 132 the access request AccessReq by checking the signature of the access request AccessReq, using 132 the public cryptographic key ta_pub_key. The communication entity CE then grants 140 access to the digital action upon successful verification of the access request.

Some aspects of how the instance of the trusted application TA may be anonymously onboarded will now be described. Onboarding can be seen as an implementation of steps 110-116 in FIG. 1C.

Generally, onboarding of the instance of the trusted application TA may involve the instance of the trusted application TA requesting a digital certificate ta_cert which includes the aforementioned public key ta pub_key, wherein the digital certificate ta_cert is being signed by the aforementioned digital certificate authority CA. Such onboarding may further involve the instance of the trusted application TA storing the digital certificate ta_cert in the secure execution environment SEE (cf. protected assets 25 in FIG. 1A and protected hardware resources 18 in FIG. 1B).

Alternatively, the private cryptographic key ta priv_key, the public cryptographic key ta pub_key and a digital certificate ta_cert which includes the public key ta_pub_key and which is signed by the digital certificate authority CA may have been pre-provisioned in the secure execution environment SEE prior to the step 110 of establishing the unique and anonymous instance of the trusted application TA in FIG. 1 1C.

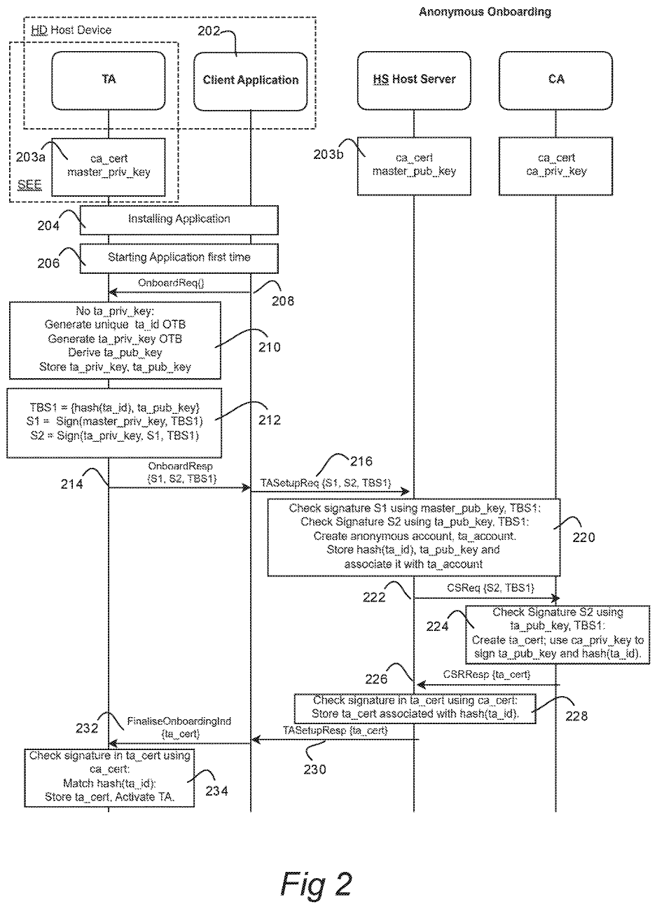

Anonymous onboarding according to one particular embodiment is illustrated in the detailed signal diagram shown in FIG. 2, which involves onboarding of the instance of the trusted application TA at a host server HS which, optionally, may be the aforementioned communication entity CE.

In FIG. 2, a client application 202 and an instance of the trusted application TA is installed in a host device HD. In the environment of FIG. 1A, the client application 202 will be a normal application NA running in the rich execution environment REE. In the environment of FIG. 1B, the client application 202 will be an application 16 requiring secure OS support and running in the rich execution environment REE.

As can be seen at 203a, the secure execution environment SEE of the host device HD is pre-provisioned with a private cryptographic master key master_priv_key. Likewise, as can be seen at 203b, the host server HS is pre-provisioned with a public cryptographic master key master pub_key corresponding to the private cryptographic master key master_priv_key.

At 204 and 206, the client application 202 and the instance of the trusted application TA are installed and executed for the first time.

As can be seen at 208, the client application 202 sends an onboarding request to the instance of the trusted application TA. At 210, the instance of the trusted application TA executes functionality that involves the following:
generating an anonymous identifier ta_id, not attributable to a user of the host device HD,
generating said private key ta_priv_key and said public key ta_pub_key of the cryptographic key pair, and
storing the private key ta_priv_key securely in the secure execution environment SEE.

At 212, the instance of the trusted application TA generates a dataset TBS1 by performing a hash operation (using ta_id as seed) on the public key ta_pub_key. The instance of the trusted application TA signs the dataset TBS1 with the private cryptographic master key master priv_key. This results in a first signature S1. Furthermore, the instance of the trusted application TA signs the first signature S1 and the dataset TBS1 using the private key ta_priv_key, resulting in a second signature S2.

At 214 and 216, the instance of the trusted application TA makes an onboarding request TASetupReq at the host server HS via an internal response OnboardResp to the client application 202. The onboarding request TASetupReq contains the first and second signatures S1, S2 as well as the dataset TBS1. In other words, the onboarding request TASetupReq is signed by the private key ta_priv_key and contains the anonymous identifier ta_id or a unique representation thereof (namely hash(ta_id)), as well as the public key ta_pub_key.

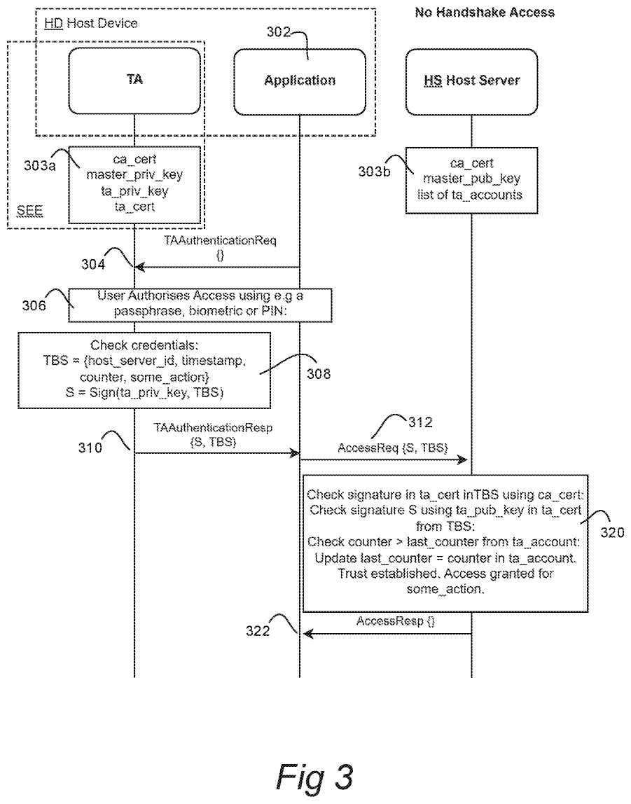

The host server HS receives the onboarding request TASetupReq at 220 and performs the following functionality:
verifying the onboarding request TASetupReq by checking the first signature S1 using the public cryptographic master key master_pub_key,
verifying the onboarding request TASetupReq additionally by checking the second signature S2 using the public key ta_pub_key,
creating an anonymous account ta_account, and
storing ta_account in association with the anonymous identifier ta_id or its unique representation (namely hash(ta_id)) as well as the public key ta pub_key from the dataset TBS; the storing is made in a list of ta_accounts kept at the host server HS (cf. 303b in FIG. 3).

The host server HS then causes creation of a digital certificate ta_cert which includes the public key ta_pub_key and the anonymous identifier ta_id or its unique representation and which is certified by said digital certificate authority CA. As seen at 222-230, this involves the following:
the host server HS sending at 222 a certificate signing request CSReq to the digital certificate authority CA, the certificate signing request CSReq comprising the anonymous identifier ta_id or the unique representation thereof (e.g. hash(ta_id)), the public key ta_pub_key and the signature S2 made by the instance of the trusted application TA when signing said onboarding request TASetupReq in the aforementioned step 212,
the digital certificate authority CA:
   at 224, verifying the signature S2 using the public key ta_pub_key,
   at 224, upon successful verification, creating the digital certificate ta_cert to include the anonymous identifier ta_id or the unique representation thereof (e.g. hash(ta_id)), the public key ta_pub_key and a signature by the digital certificate authority CA, and
   at 226, delivering the digital certificate ta_cert to the host server HS, and
the host server HS receiving the digital certificate ta_cert from the digital certificate authority CA in step 228, checking the CA's signature using a CA digital certificate ca_cert and storing the digital certificate ta_cert in association with ta_account.

Following this, the host server HS delivers the digital certificate ta cert to the host device HD in step 230. The client application 202 forwards it at step 232 to the instance of the trusted application TA.

In step 234, the instance of the trusted application TA verifies that the digital certificate ta_cert has been certified by the digital certificate authority CA, using the CA digital certificate ca_cert, before storing the digital certificate ta_cert in the secure execution environment SEE. The instance of the trusted application TA may thus be activated.

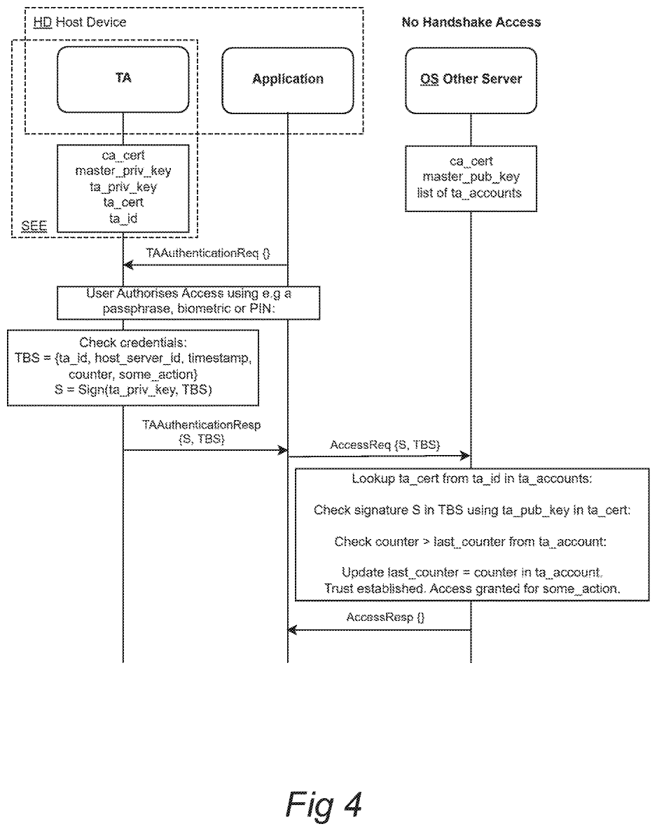

FIG. 3 and FIG. 4 are detailed signal diagrams illustrating privacy enabling access to a digital action without handshakes in two different embodiments. Essentially, the difference between the two is that in FIG. 3, the instance of the trusted application TA causes transmission of the access request AccessReq to the aforementioned host server HS, whereas in FIG. 4, the instance of the trusted application TA causes transmission of the access request AccessReq to a remote server OS (other server), not being said host server HS. In such an embodiment, the digital certificate ta_cert may be included in the access request (albeit not shown in FIG. 4).

FIG. 3 and FIG. 4 are exemplary implementations of steps 120 to 140 in FIG. 1C. In FIG. 3, the client application 302 in the host device HD sends an authentication request to the instance of the trusted application TA at 304. At 306, the user of the host device HD authorizes access to the digital action in some available manner of authentication, such as by way of biometry or inputting a passphrase or PIN code.

At 308, upon successful user authorization, the instance of the trusted application TA generates a dataset TBS which comprises an identifier host_server id of the host server HS, a timestamp, a counter and an identifier some_action of the digital action to be accessed at the host server HS. The instance of the trusted application TA signs the generated dataset TBS using the private cryptographic key ta_priv_key as maintained in the secure execution environment SEE at 303a. This results in a digital signature S.

At 310 and 312, the instance of the trusted application TA sends an access request AccessReq to the host server HS via the client application 302. The access request AccessReq contains the signature S and the dataset TBS.

Upon receipt of the access request AccessReq, the host server HS performs the following functionality at 320. It is recalled that the digital certificate ta cert of the instance of the trusted application TA is maintained in the aforementioned list of ta_accounts by the host server HS. Additionally, it is recalled that the CA digital certificate ca_cert is maintained by the host server HS. This can be seen at 303b. The host server HS checks the signature in the digital certificate ta_cert of the instance of the trusted application TA using the CA digital certificate ca_cert. Furthermore, the host server HS checks the signature S using the public cryptographic key ta_pub_key in the digital certificate ta_cert. Finally, as a means for preventing fraudulent rollback, the host server HS checks that the counter in the dataset TBS indicates that an execution state of the instance of the trusted application TA has not already been occupied. This is done by comparing to a stored value last counter.

Provided that this verification of the access request AccessReq is successful (affirmative checks), the host server HS updates last_counter by setting it to the counter in the dataset TBS. The host server HS concludes that trust has been established and therefore grants access to the requested digital action as indicated by the identifier some action. A confirmation is sent to the host device HD at 322.

Granting access to the digital action by the host server HS (communication entity CE) may involve permitting usage of a digital asset in the anonymous digital account ta_account. It is recalled that the anonymous digital account ta_account has been associated previously with the instance of the trusted application TA and the public cryptographic key ta pub_key upon onboarding of the instance of the trusted application TA at the host server HS. Therefore, after having verified the access request AccessReq, the host server HS (communication entity CE) may locate the anonymous digital account ta_account through its association with the instance of the trusted application TA and the public cryptographic key ta_pub_key, as maintained in the aforementioned list of ta accounts.

The digital asset may represent or include a finite digital resource, such as a balance of a digital wallet for digital payment applications, or a service subscription or license scheme. The digital asset may alternatively represent or include encryption keys used to secure communications, authentication credentials, financial data, health records, biometric data, digital certificates, digital rights management control data, system and network configurations, operational data, corporate data, legal documents, source code and software artefacts, government classified information, research data, communication logs, access control lists, emergency recovery protocols, intellectual property, proprietary algorithms, personal user data, or any other type of data that is considered valuable.

FIG. 5 is a detailed signal diagram illustrating anonymous payment in one embodiment. Hence, in this embodiment, the anonymous digital account ta_account is a digital wallet. The digital asset is a balance of the digital wallet. The digital action is a digital payment, Payment, in a payment amount to be debited from the balance of the digital wallet. The trusted application TA supports a payment application 502 executed by the host device HD. The user of the host device HD uses the payment application 502 to act as payer of the digital payment to a payee being a receiver of the digital payment. The payee uses a receiving application 501 in another device, which may be a host device of any of the kinds referred to previously in this document. The communication entity is a host server HS in the form of a payment processing server.

The payee requests a payment in a certain amount at 504a, indicating also an identifier receiverID of the payee and a request identifier reqID. The payment application 502 forwards the payment request to the instance of the trusted application TA at 504b. At 506, the payer authorizes the digital payment in some available manner of authentication, such as by way of biometry or inputting a passphrase or PIN code.

At 508, upon successful user authorization, the instance of the trusted application TA checks that the requested payment amount complies with certain risk limits RL previous set and maintained at 503a. The instance of the trusted application TA then generates a dataset TBS which comprises the identifier receiverID of the payee, the payment amount and the request identifier reqID. The instance of the trusted application TA signs the generated dataset TBS using the private cryptographic key ta_priv_key as maintained in the secure execution environment SEE at 503a. This results in a digital signature S. The host device HD may store (buffer) the digital payment locally.

At 510 and 512, the instance of the trusted application TA sends a payment request Payment to the host server HS via the client application 302. The payment request Payment contains the signature S and the dataset TBS.

Upon receipt of the payment request Payment, the host server HS performs the following functionality at 520. Like in FIG. 3, the digital certificate ta_cert of the instance of the trusted application TA as well as the CA digital certificate ca cert are maintained by the host server HS, see 503b. The host server HS checks the signature in the digital certificate ta_cert of the instance of the trusted application TA using the CA digital certificate ca_cert. Furthermore, the host server HS checks the signature S using the public cryptographic key ta_pub_key in the digital certificate ta_cert. Optionally, if the receiving application 501 has previously alerted the host server HS of the requested digital payment and the request identifier reqID (not shown as such in the drawing), the host server HS may check that there is match with the request identifier reqID in the dataset TBS.

Provided that this verification of the access request AccessReq is successful (affirmative checks), the host server HS concludes that trust has been established and therefore grants access to the requested digital action by clearing the digital payment. Confirmations are sent to the host device HD (i.e., the payer) at 522a and the payee at 522b. The host server HS may store (buffer) the digital payment locally.

Final settlement of the digital payment takes place at 530 and may be triggered directly from the host server HS, or from either of the host device HD (i.e., the payer) and/or the payee by uploading the locally stored (buffered) digital payment to a resource in a payment network capable of settling the digital payment. In some embodiments, the host server HS being a payment processing server causes settlement of the digital payment to credit the payment amount to a receiving digital account associated with a payee.

Note that after settlement, the payment amount as such but no origin of the digital payment in terms of an identity of the payer as the user of the host device HD is traceable by the payee or the payment processing server. In some embodiment, also the payee may obtain some privacy by indicating the payee in the payment request Payment (cf. 504a, 504b) in the form of an anonymous identifier (cf. receiverID) of an instance of a trusted application in a secure execution environment of a host device operated by the payee, the identity of the payee therefore not being traceable by the payer or the payment processing server.

Some non-limiting examples of suitable technology for digital payments are described in the present applicant's PCT applications PCT/SE2020/051251, PCT/SE2021/050556, PCT/SE2022/050090 and PCT/SE2022/050152, as well as Swedish applications SE 2151401-3 and SE 2250076-3, each of which is incorporated herewith by reference.

As will be readily understood by the skilled reader of the present disclosure, the invention may take the form of a host device HD comprising a secure execution environment SEE, the host device HD being configured for:
establishing a unique and anonymous instance of a trusted application TA, executable in the secure execution environment SEE, by associating the instance with a cryptographic key pair comprising a private cryptographic key ta_priv_key and a public cryptographic key ta_pub_key, the public cryptographic key ta_pub_key being certified by a digital certificate authority CA and at least the private cryptographic key ta_priv_key being stored securely in the secure execution environment SEE; and
from the instance of the trusted application TA, generating and causing transmission of an access request AccessReq for a digital action at a communication entity CE; HS, OS, the access request being signed by the private cryptographic key ta_priv_key, thereby enabling the communication entity CE; HS, OS to verify the access request AccessReq by checking the signature of the access request AccessReq using the public cryptographic key ta_pub_key, and to grant access to the digital action upon successful verification of the access request.

As will also be readily understood by the skilled reader of the present disclosure, the invention may take the form of a trusted application TA comprising computer program code being executable in a secure execution environment SEE of a host device HD, the trusted application TA being configured for:
establishing itself as a unique and anonymous trusted application instance by associating the instance with a cryptographic key pair comprising a private cryptographic key ta_priv_key and a public cryptographic key ta_pub_key, the public cryptographic key ta_pub_key being certified by a digital certificate authority CA and at least the private cryptographic key ta_priv_key being stored securely in the secure execution environment SEE; and
generating and causing transmission of an access request accessReq for a digital action at a communication entity CE; HS, OS, the access request being signed by the private cryptographic key ta priv_key, thereby enabling the communication entity CE; HS, OS to verify the access request AccessReq by checking the signature of the access request AccessReq using the public cryptographic key ta pub_key, and to grant access to the digital action upon successful verification of the access request.

As will also be readily understood by the skilled reader of the present disclosure, the invention may take the form of a computerized resource being configured for:
receiving an access request AccessReq for a digital action from a unique and anonymous instance of a trusted application TA, executable in a secure execution environment SEE of a host device HD and having been established by associating the instance with a cryptographic key pair comprising a private cryptographic key ta_priv_key and a public cryptographic key ta pub_key, the public cryptographic key ta_pub_key being certified by a digital certificate authority CA and at least the private cryptographic key ta_priv_key being stored securely in the secure execution environment SEE, the access request being signed by the private cryptographic key ta_priv_key;
verifying the access request AccessReq by checking the signature of the access request AccessReq using the public cryptographic key ta_pub_key; and
granting access to the digital action upon successful verification of the access request.

The invention has mainly been described above with reference to a few embodiments. However, as is readily appreciated by a person skilled in the art, other embodiments than the ones disclosed above are equally possible within the scope of the invention, as defined by the appended patent claims.

1. A computerized privacy enabling method, comprising:
establishing unique and anonymous instance of a trusted application, executable in a secure execution environment of a host device, by associating the instance with a cryptographic key pair comprising a private cryptographic key and a public cryptographic key, the public cryptographic key being certified by a digital certificate authority and at least the private cryptographic key being stored securely in the secure execution environment;
from the instance of the trusted application, generating and causing transmission of an access request for a digital action at a communication entity, the access request being signed by the private cryptographic key;
the communication entity verifying the access request by checking the signature of the access request using the public cryptographic key; and
the communication entity granting access to the digital action upon successful verification of the access request.

2. The method according to claim 1, further comprising onboarding of the instance of the trusted application by:
the instance of the trusted application requesting a digital certificate which includes the public key, the digital certificate being signed by the digital certificate authority; and
the instance of the trusted application storing the digital certificate in the secure execution environment.

3. The method according to claim 1, wherein the private cryptographic key, the public cryptographic key and a digital certificate which includes the public key and which is signed by the digital certificate authority have been pre-provisioned in the secure execution environment prior to the step of establishing the unique and anonymous instance of the trusted application.

4. The method according to claim 1, comprising onboarding of the instance of the trusted application at a host server optionally being said communication entity:
the instance of the trusted application:
generating an anonymous identifier not attributable to a user of the host device;
generating said private key and said public key of the cryptographic key pair;
storing the private key securely in the secure execution environment; and
making an onboarding request at the host server, the onboarding request being signed by the private key and containing the anonymous identifier or a unique representation thereof as well as the public key;
the host server:
verifying the onboarding request by the public key;
causing generation of a digital certificate which includes the public key and the anonymous identifier or its unique representation and which is certified by said digital certificate authority; and
delivering the digital certificate to the host device; and
the instance of the trusted application:
storing the digital certificate in the secure execution environment.

5. The method according to claim 4, wherein the instance of the trusted application verifies that the digital certificate has been certified by the digital certificate authority before storing the digital certificate in the secure execution environment.

6. The method according to claim wherein causing generation of the digital certificate by the host server involves:
the host server sending a certificate signing request to the digital certificate authority, the certificate signing request comprising the anonymous identifier or the unique representation thereof, the public key and a signature made by the instance of the trusted application when signing said onboarding request; and
the digital certificate authority:
verifying the signature using the public key;
creating the digital certificate to include the anonymous identifier or the unique representation thereof-(hash(ta the public key key)-and a signature by the digital certificate authority; and
delivering the digital certificate to the host server.

7. The method according to claim 4, wherein:
the secure execution environment of the host device is pre-provisioned with a private cryptographic master key;
the host server is pre-provisioned with a public cryptographic master key corresponding to the private cryptographic master key;
the instance of the trusted application signs the onboarding request by the private cryptographic master key; and
the host server verifies the onboarding request also by the public cryptographic master key.

8. The method according to claim 1, wherein the instance of the trusted application causes transmission of the access request to said remote server or said another remote server being said host server.

9. The method according to claim 2, wherein the instance of the trusted application causes transmission of the access request to said remote server or said another remote server not being said host server, the digital certificate being included in the access request.

10. The method according to claim 1,
wherein the communication entity granting access to the digital action involves permitting usage of a digital asset in an anonymous digital account

11. The method according to claim 10, wherein the anonymous digital account has been associated previously with the instance of the trusted application and the public cryptographic key upon onboarding of the instance of the trusted application at a host server.

12. The method according to claim 11, wherein after having verified the access request, the communication entity locates the anonymous digital account through its association with the instance of the trusted application and the public cryptographic key.

13. The method according to claim 10, wherein:
the trusted application supports a payment application executed by the host device;
said communication entity is a payment processing server;
the anonymous digital account is a digital wallet;
the digital asset is a balance of the digital wallet; and
the digital action is a digital payment in a payment amount to be debited from the balance of the digital wallet.

14. The method according to claim 13, further comprising the payment processing server causing settlement of the digital payment to credit the payment amount to a receiving digital account associated with a payee.

15. The method according to claim 14, wherein after settlement the payment amount as such but no origin of the digital payment in terms of an identity of a payer being a user of the host device is traceable by the payee or the payment processing server.

16. The method according to claim 15, wherein the payee is indicated in the access request in the form of an anonymous identifier of an instance of a trusted application in a secure execution environment of a host device operated by the payee, the identity of the payee therefore not being traceable by the payer or the payment processing server.

17. The method according to claim 1, wherein the secure execution environment of the host device is a software-based virtual execution environment which includes encrypted protected assets being accessible to the instance of the trusted application when executed in the software-based virtual execution environment.

18. A host device comprising a secure execution environment, the host device being configured for:
establishing a unique and anonymous instance of a trusted application, executable in the secure execution environment, by associating the instance with a cryptographic key, pair comprising a private cryptographic key and a public cryptographic key the public cryptographic key being certified by a digital certificate authority and at least the private cryptographic key being stored securely in the secure execution environment; and
from the instance of the trusted application generating and causing transmission of an access request for a digital action at a communication entity-(CE; the access request being signed by the private cryptographic key thereby enabling the communication entity to verify the access request by checking the signature of the access request using the public cryptographic key, and to grant access to the digital action upon successful verification of the access request.

19. (canceled)

20. A trusted application comprising computer program code being executable in a secure execution environment of a host device, the trusted application being configured for:
establishing itself as a unique and anonymous trusted application instance by associating the instance with a cryptographic key pair comprising a private cryptographic key and a public cryptographic key, the public cryptographic key being certified by a digital certificate authority and at least the private cryptographic key being stored securely in the secure execution environment; and
generating and causing transmission of an access request for a digital action at a communication entity, the access request being signed by the private cryptographic key, thereby enabling the communication entity to verify the access request by checking the signature of the access request using the public cryptographic key and to grant access to the digital action upon successful verification of the access request.

21. (canceled)

22. A computerized resource being configured for:
receiving an access request for a digital action from a unique and anonymous instance of a trusted application, executable in a secure execution environment of a host device and having been established by associating the instance with a cryptographic key pair comprising a private cryptographic key and a public cryptographic key, the public cryptographic key being certified by a digital certificate authority and at least the private cryptographic key being stored securely in the secure execution environment, the access request being signed by the private cryptographic key;
verifying the access request by checking the signature of the access request using the public cryptographic key; and
granting access to the digital action upon successful verification of the access request.

23. (canceled)
